(19) United States
(12) Patent Application Publication
(10) Pub. No.: US 2019/0145155 A1
(43) Pub. Date: May 16, 2019

(54) SASH FOR A SLIDING WINDOW OR A SLIDING DOOR AND METHOD FOR PROVIDING AN UNTREATED METAL SURFACE IN SUCH A SASH

(71) Applicant: TECHNOFORM BAUTEC HOLDING GMBH, Kassel (DE)

(72) Inventors: Stefano MINELLI, Lainate (IT); Alice TORRICELLI, Lainate (IT)

(21) Appl. No.: 16/098,241

(22) PCT Filed: Apr. 28, 2017
(86) PCT No.: PCT/EP2017/060183

§ 371 Date: Nov. 1, 2018

(30) Foreign Application Priority Data
May 3, 2016 (EP) 16168205.9

(51) Int. Cl. E06B 3/263

(52) U.S. Cl. CPC E06B 3/26347; E06B 2003/2637; E06B 2003/26383; E06B 3/26303

(57) ABSTRACT

A sash (2) for a sliding window (1) or a sliding door includes at least two aluminium members (4, 5) connected by one or more insulating strips (7, 8). The two aluminium members (4, 5) and one of the insulating strips (7) at least partially confine a cavity (9) having a first side (10) in a direction (y) perpendicular to a plane (x-z) in which the sash (2) extends and a second side (11) opposite to the first side (10). A low emissivity surface (6a) is disposed along the first side (10) or the second side (11) and has an emissivity ε of less than or equal to 0.3.

The present invention relates to a sash for a sliding window or a sliding door, and a method for providing a surface of untreated aluminium in such a sash.

Sliding windows and sliding doors are well known. Usually, one or more sliding sashes are disposed within a fixed window frame or a fixed door frame and are slidable in a horizontal or vertical direction for closing and opening the sliding window or the sliding door. The sashes usually support glazing panes such as insulating glazing units (IGUs) or other elements. Examples of a sliding or door comprising sliding sashes are shown in GB 982,026 and EP 1 353 034 A2, respectively.

Nowadays, sashes for sliding windows or doors mounted in outer walls of buildings are usually formed by composite profiles to reduce heat transfer between inner sides and outer sides of the buildings.

The use of composite profiles for thermal insulation is generally known for windows and doors. Often, such a composite profile comprises inner and outer metallic members and one or more insulating members connecting the metallic members.

DE 195 12 317 C1 discloses an insulating member for window or door frames/sashes consisting of two insulating strips and two foil strips disposed between the two insulating strips and spanning the space between the two insulating strips. The foil strips inhibit convection and reduce thermal radiation in a space between the two insulating strips.

DE 94 13 790 U1 discloses two insulating strips and an insulating element of PUR foam disposed between the two insulating strips. Reflecting metal foils are disposed on opposite surfaces of the insulating element.

DE 43 25 972 C1 discloses two insulating strips and a hose with a reflecting outer surface which is disposed between the two insulating strips.

WO 2014/063812 A1 discloses an insulating strip having a transverse projection extending into a space between two insulating strips. A surface of the transverse projection may be coated with metal.

A composite profile of a sash for a sliding window or door generally comprises a cavity in a space between the metallic members, which comprises hardware for locking the sliding window or sliding door. The cavity must be big enough to comprise the hardware such that heat transfer caused by thermal radiation and convection is promoted.

Such a cavity is usually located at one lateral side between the inner and outer sides (cold and warm sides) of the sash.

It is known to fill at least a part of such a cavity with foam to reduce heat transfer caused by thermal radiation or convection.

An object of the present invention is to provide an improved sash for a sliding window or a sliding door with good thermal properties.

This object is achieved by a sash according to claim 1 or a method according to claim 15.

Further developments of the invention are given in the dependent claims.

By disposing the low emissivity surface along the first side or the second side of the cavity, low heat transfer caused by thermal radiation can be achieved.

The low emissivity surface may be an untreated surface of one of the metallic members, such as an untreated aluminium surface, or a surface of a foil with low emissivity that is disposed on one of the metallic members or on a plastic member positioned in the cavity.

The emissivity ε of the low emissivity surface can be equal to or less than 0.3, 0.1, 0.05, 0.03, or 0.02 depending on the material on which the low emissivity surface is provided.

Additional features and advantages result from the description of exemplary embodiments by reference to the figures, which show in

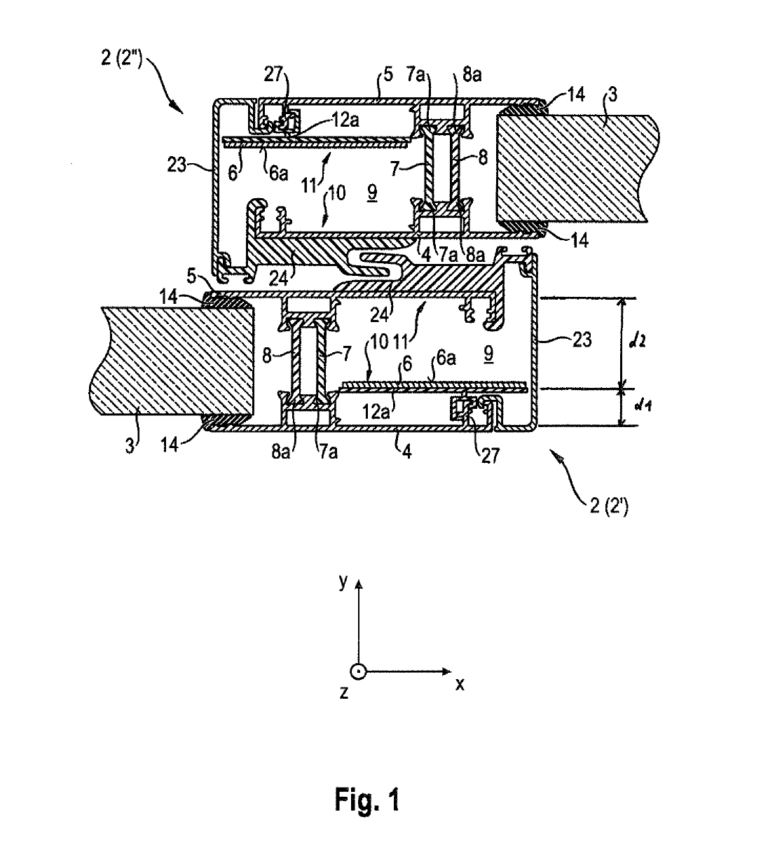

FIG. 1 a partial cross-section of two sashes of a sliding window according to an embodiment in a plane perpendicular to a longitudinal direction of the sashes,

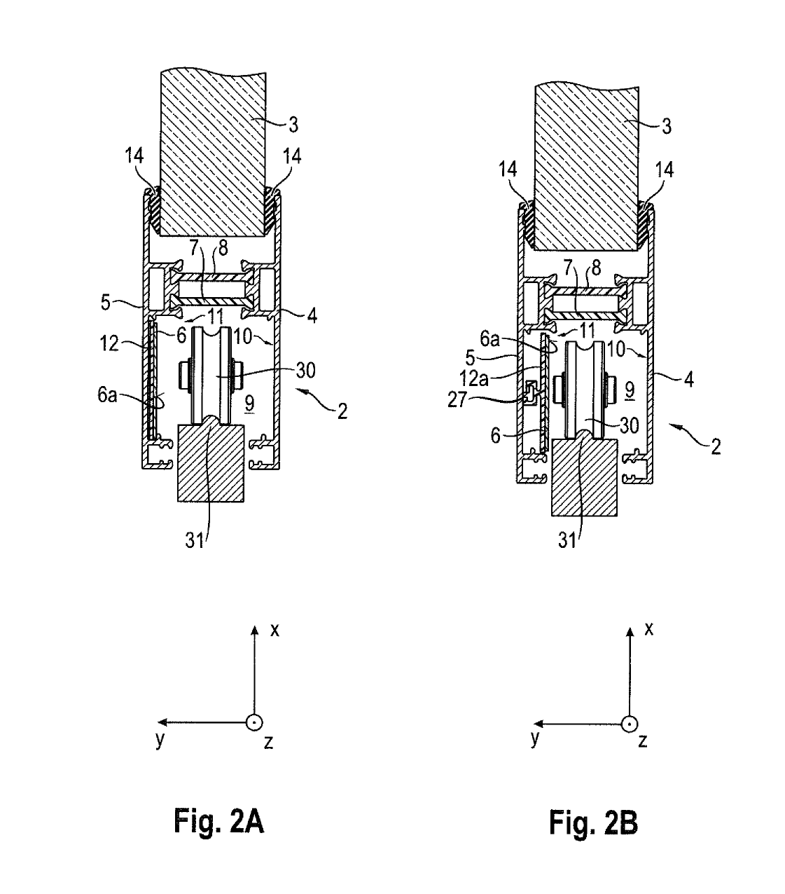

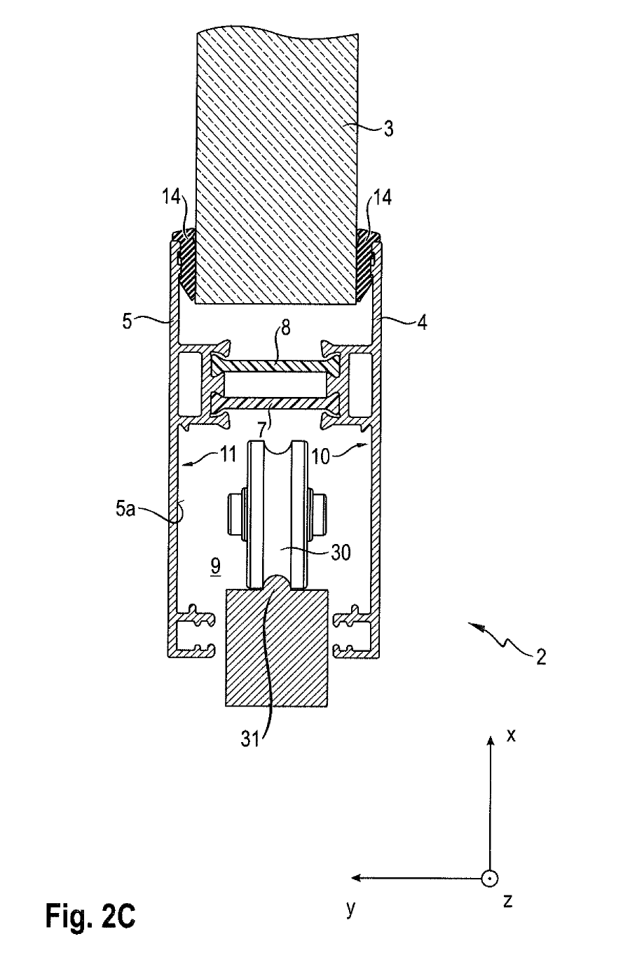

FIG. 2A a partial cross-section of a sash according to another embodiment in a plane perpendicular to the longitudinal direction,

FIG. 2B a partial cross-section of a sash according to another embodiment in a plane perpendicular to the longitudinal direction,

FIG. 2C a partial cross-section of a sash according to another embodiment in a plane perpendicular to the longitudinal direction,

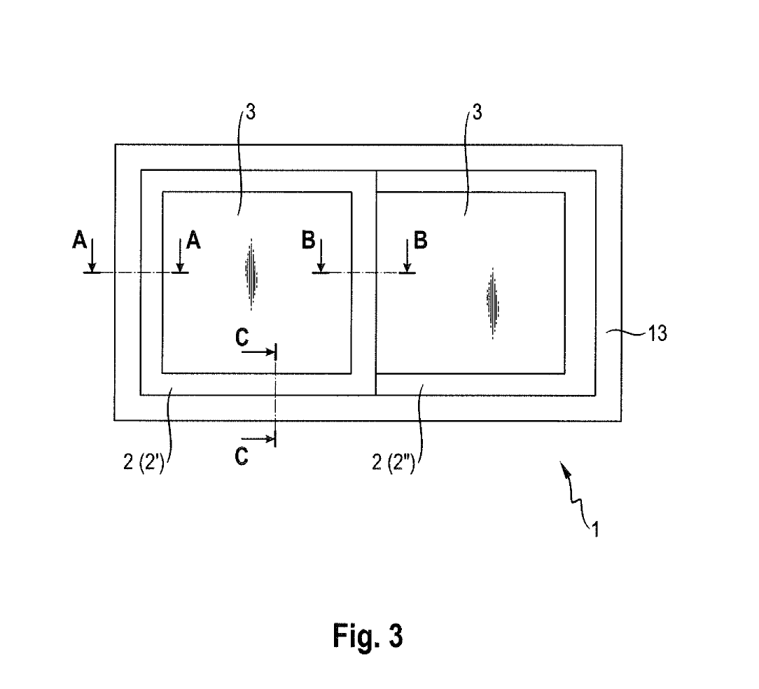

FIG. 3 a front view of a sliding door or window assembly, and

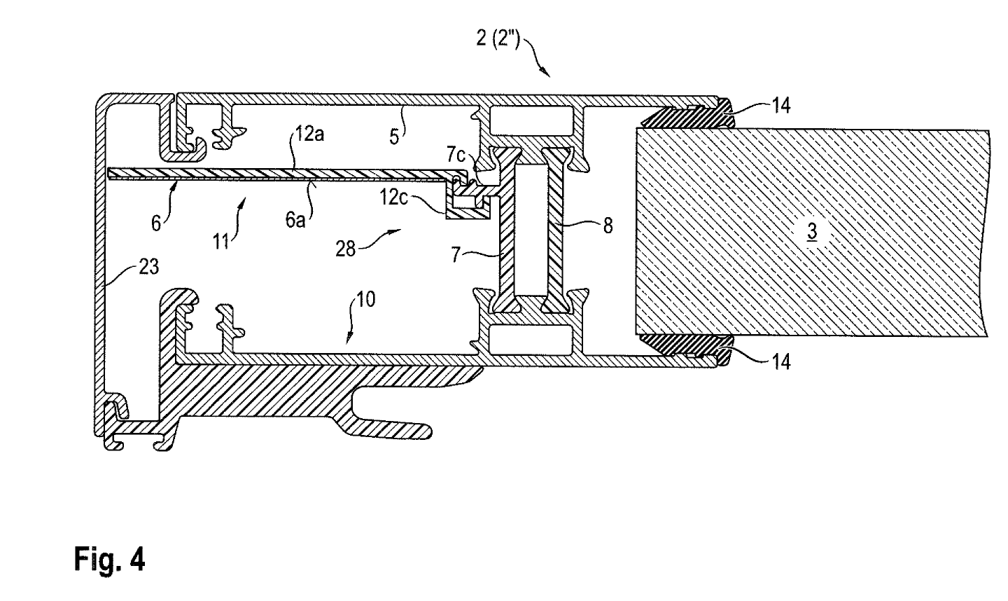

FIG. 4 a partial cross-section of a sash according to another embodiment in a plane perpendicular to the longitudinal direction.

FIG. 1 shows a partial cross-section of two sashes 2 of a sliding window 1 in a plane perpendicular to a longitudinal direction z of the sashes 2 corresponding to the cross-section B-B in FIG. 3. The partial cross-section shown in FIG. 1 is taken in an overlap region of the two sashes 2 and shows a closed state of the sliding window 1. A first sash 2 (2′) is shown on the lower side in FIG. 1 and a second sash 2 (2″) is shown on the upper side in FIG. 1.

For opening the sliding window 1, the first sash 2 (2′) is moved to the right and/or the second sash 2 (2″) is moved to the left, i.e., the two sashes 2 are moved relative to each other in the horizontal direction of FIG. 3.

The first sash 2 (2′) will be described in the following with reference to FIG. 1.

The first sash 2 (2′) supports an IGU 3 of the sliding window 1. The IGU 3 is an insulating glazing unit comprising plural insulated glazing panes as known in the art and extends in the longitudinal direction z and in a lateral direction x, which is perpendicular to the longitudinal direction z. The cross-section of the first sash 2 is essentially constant along the longitudinal direction z. The first sash 2 is disposed along edges of the IGU 3 as shown in FIG. 3. A width direction y is perpendicular to the longitudinal direction z and the lateral direction x. The first sash 2 (2′) overlaps the second sash 2 (2″) in the width direction y.

The first sash 2 (2′) comprises two aluminium members 4, 5. The aluminium members 4, 5 are formed as profiles extending in the longitudinal direction z. A lateral width of each of the aluminium members 4, 5 in the lateral direction x is in the range from 1 cm to 10 cm. A width of each of the aluminium members 4, 5 in the width direction y is in a range from 0.2 cm to 10 cm, or in the range from 0.3 cm to 2 cm. A wall thickness of the aluminium members 4, 5 is in a range from 1 mm to 3 mm. A first aluminium member 4 of the two aluminium members 4, 5 is disposed on an inner side of the sliding window 1. A second aluminium member 5 of the two aluminium members 4, 5 is disposed on an outer side of the sliding window 1. The terms “inner side” and “outer side” refer to an inner side and an outer side, respectively, of a building in which the sliding window 1 is assembled.

The aluminium members 4, 5 are opposite to each other in the width direction y and are connected to each other by two insulating strips 7, 8. A distance between the aluminium members in the width direction y is in a range from 0.5 cm to 10 cm.

The insulating strips 7, 8 are made of plastic material such as PA, PBT, PA-PBE, PET, PMI, PVC, PUR, ABS and PP. The insulating strips 7, 8 can comprise foamed, cellular, and/or porous plastic material. The insulating strips 7, 8 can comprise reinforcing elements such as glass fibers (for instance, the material of the insulating strips 7, 8 can be PA66GF25) and/or can be made of bio polymers, which are based on renewable resources. Examples for polymers, which can be based on renewable resources, are PA 5.5, PA 5.10, PA 6.10, PA 4.10, PA 10.10, PA 11, PA 10.12. The insulating strips 7, 8 can be made of plastic material with low thermal conductivity.

The insulating strips 7, 8 extend along the longitudinal direction z. A wall thickness of each of the insulating strips 7, 8 in the lateral direction x is in a range from 0.5 mm to 3 mm. A width of each of the insulating strips 7, 8 in the width direction y is in a range from 0.5 cm to 10 cm. The insulating strips 7, 8 comprise connection ends such as, e.g., dovetail-shaped ends 7a, 8a in the width direction y compatible with the Technoform aluminium standard groove described in the 2012 Technoform Standard Profile Catalogue. The dovetail-shaped ends 7a, 8a are inserted into grooves of the aluminium members 4, 5. The dovetail-shaped ends 7a, 8a can be held in the grooves by so-called “rolling-in”, wherein edges of the grooves are deformed towards the dovetail-shaped ends 7a, 8a after inserting the dovetail-shaped ends 7a, 8a into the grooves.

The insulating strips 7, 8 are spaced apart in the lateral direction x. A distance between the insulating strips 7, 8 in the lateral direction x is in the range from 1 cm to 10 cm. A first insulating strip 7 of the two insulating strips 7, 8 is disposed on a side opposite to the IGU 3 with respect to the other one of the insulating strips 7, 8, which is a second insulating strip 8.

The IGU 3 is disposed between the aluminium members 4, 5 on one side of the first sash 2 in the lateral direction x. The IGU 3 is connected to the aluminium members 4, 5 via support members 14 arranged on both sides of the IGU 3 in the width direction y.

A cavity 9 is formed on a side opposite to the IGU 3 with respect to the first insulating strip 7 and between the aluminium members 4, 5. The cavity 9 is confined by the first insulating strip 7 and the aluminium members 4, 5. The term “confined” in this context means that the first insulating strip 7 and the aluminium members 4, 5 define the cavity 9 in the cross-section perpendicular to the longitudinal direction z. The cavity 9 extends along the longitudinal direction z and may be open at the ends in the longitudinal direction z. The cavity 9 may or may not be completely surrounded by the first insulating strip 7 and the aluminium members 4, 5.

A side of the cavity 9 opposite to the IGU 3 in the lateral direction x is covered by a third aluminium member 23. The third aluminium member 23 prevents dust from entering the cavity 9. The third aluminium member 23 may also be provided for aesthetic reasons hiding the cavity 9.

The cavity 9 comprises a first side 10 on an inner side of the sliding window 1 in the width direction y and a second side 11 on an outer side of the sliding window 1. The first side 10 is opposite to the second side 11. The inner side of the sliding window 1 is disposed on the inner side of a building, and the outer side of the sliding window 1 is disposed on an outer side of the building.

A height of the cavity 9 in the width direction y is in a range from 0.5 cm to 20 cm. A width of the cavity 9 in the lateral direction x is in a range with a lower limit of 1 cm, or 2 cm and an upper limit of 2.5 cm, 5 cm, 10 cm, or 20 cm.

A plastic profile 12a is disposed on the first side 10 of the cavity 9. The plastic profile 12a can be made of the same group of materials as the insulating strips 7, 8. A wall thickness of the plastic profile 12a is in a range of 0.1 mm to 3 mm. A width of the plastic profile 12a in the lateral direction x is in a range of 5 mm to 100 mm.

The plastic profile 12a extends essentially parallel to the first side 10. The plastic profile 12a extends along the longitudinal direction z with an essentially constant cross-section. The plastic profile 12a is connected to the first aluminium member 4 via a clip connection 27. The plastic profile 12a comprises an essentially flat surface on a side opposite to the first aluminium member 4, which faces the cavity 9.

A foil 6 is disposed on the essentially flat surface of the plastic profile 12a. A thickness of the foil 6 is in a range from 1 μm to 1 mm. A surface 6a of the foil 6 opposite to the plastic profile 12a and facing the cavity 9 has an emissivity ε of less than or equal to 0.1. The surface 6a of the foil 6 can be made of a metal with a sufficiently low emissivity as described above. The surface 6a can be made of aluminium. The foil 6 can be made of a metal with a sufficiently low emissivity. The foil 6 can be made of aluminium.

There is hardly any thermal radiation emitted from the surface 6a due to this low emissivity. Accordingly, heat transfer caused by thermal radiation from the first side 10 of the cavity 9 to the second side 11 is reduced.

The cavity 9 does not comprise foam. The cavity 9 may comprise hardware for locking the sliding window 1 in a closed state or an open state or a partly open state.

A first distance d1 of the plastic profile 12a with the foil 6 from the first aluminium member 4 on the first side 10 is smaller than a second distance d2 of the plastic profile 12a from the second aluminium member 5 on the second side 11, which the surface 6a of the foil 6 is facing. Therefore, there is sufficient space for disposing hardware in the cavity 9. The second distance d2 can be larger than 1.0 or 1.2 or 1.5 or 1.7 or 2 or 3 or 5 or 10 or 20 times the first distance d1.

The second sash 2 (2″) essentially corresponds to the first sash except for the fact that the plastic profile 12a of the second sash 2″ is disposed along the second side 11 of the cavity 9 and is connected to the second aluminium member 5 via a clip connection 27.

Each of the two sashes 2 comprises an intervening member 24 disposed between the two sashes 2 in the overlap region. One of the intervening members 24 is connected to the second aluminium member 5 and the third aluminium member 23 of the first sash 2 (2′). The other one of the intervening members 24 is connected to the first aluminium member 4 and the third aluminium member 23 of the second sash 2 (2″). The intervening members 24 are made of plastic material.

FIG. 2A shows a partial cross-section of a sash 2 according to another embodiment in a plane perpendicular to the longitudinal direction z corresponding to the cross-section C-C in FIG. 3.

The partial cross-section shown in FIG. 2A is taken in a region, in which the sash 2 abuts to a fixed window frame 13. The sash 2 abuts to the fixed window frame 13 on the lower side in FIG. 2A.

The cavity 9 of the sash 2 is open on the bottom side in FIG. 2A, which faces the fixed window frame 13, and does not comprise the third aluminium member 23 in this region. A roller or reel 30 is provided in the cavity 9. Although not shown in the figure, the roller 30 is connected to either one or both of the first and second aluminium members 4, 5. The roller 30 is supported by a guide rail 31 provided on the top side of the fixed window frame 13, which faces the sash 2. The guide rail 31 protrudes into the cavity 9. The roller 30 runs along the guide rail 31 in the longitudinal direction z during opening and closing the sliding window 1.

The sash 2 corresponds to one of the two sashes 2 of the embodiment described above except for the fact that the sash 2 comprises a plastic strip 12 instead of the plastic profile 12a. The plastic strip 12 is disposed on the second side 11 of the cavity 9. The plastic strip 12 may be inserted into a groove of the second aluminium member 5 and may be held in the groove.

The foil 6 is disposed on the surface of the plastic strip 12 facing the cavity 9. The low emissivity surface 6a of the foil 6 faces the cavity 9.

FIG. 2B shows a partial cross-section of a sash 2 according to another embodiment in the plane perpendicular to the longitudinal direction z corresponding to the cross-section C-C in FIG. 3.

The sash 2 shown in FIG. 2B corresponds to the sash 2 shown in FIG. 2A except for the fact that the plastic profile 12a is provided instead of the plastic strip 12.

FIG. 2C shows a partial cross-section of a sash 2 according to another embodiment in the plane perpendicular to the longitudinal direction z corresponding to the cross-section C-C in FIG. 3.

The sash 2 shown in FIG. 2C corresponds to the sash 2 shown in FIG. 2A except for the fact that the plastic strip 12 and the foil 6 are not provided.

A surface 5a of the second aluminium member 5 facing the cavity 9 on the second side 11 is an untreated aluminium surface. An emissivity ε of the surface 5a is about 0.1 or less.

The surface 5a or a part of the surface 5a is covered by a protecting foil during manufacturing steps after extrusion of the same such as a surface treatment or powder coating or polishing or anodising or the like to achieve such a low emissivity. The protecting foil prevents the part of the surface 5a that is covered by the protecting foil from being treated during such a surface treatment. The emissivity ε of the surface 5a could increase if the surface 5a is treated. The protecting foil is removed after the surface treatment uncovering the surface 5a of untreated aluminium.

The surface 5a of untreated aluminium may be covered by dust entering the cavity 9 during the lifetime of the sliding window 1. The emissivity ε of the surface 5a may increase due to the dust. Low heat transfer caused by thermal radiation can be ensured as long as the emissivity 8 does not exceed 0.3.

FIG. 4 shows a partial cross-section of a sash 2 according to another embodiment in the plane perpendicular to the longitudinal direction. The sash 2 corresponds to the second sash 2 (2″) of the embodiment shown in FIG. 1 except for the fact that the plastic profile 12a is connected to the first insulating strip 7 instead of the second aluminium member 5. The plastic profile 12a is connected to the first insulating strip 7 via a clip connection 28 formed by one clip part 7c at the first insulating strip 7 and a complementary clip part 12c at the plastic profile 12a. The plastic profile 12a extends from the first insulating strip 7 into the cavity 9 along the second side 11.

FIGS. 1 and 4 show partial cross-sections of sashes 2 according to line B-B in FIG. 3 in a region where the first sash 2 (2′) and the second sash 2 (2″) overlap in the width direction y. FIGS. 2A to 2C show partial cross-sections of sashes 2 according to line C-C in FIG. 3 in a region where the sash 2 abuts to the fixed window frame 13 on a bottom side of the sash 2 in FIG. 3. A configuration of the sash 2 in a region where the sash 2 abuts to the fixed window frame 13 on a top side of the sash 2 in FIG. 3 may correspond to one of the configurations shown in FIGS. 2A to 2C. A configuration of the sash 2 in a region abutting to the fixed window frame 13 on a lateral side of the sash 2 indicated by line A-A in FIG. 3 may correspond to one of the configurations shown in FIG. 2A to 2C except for the fact that the roller 30 may not be provided in the lateral side region of the sash 2. The third aluminium member 23 may be provided or may not be provided in the lateral side region of the sash 2 depending on the configuration of the fixed window frame 13. A sealing member sealing between the sash 2 and the fixed window frame 13 may be provided in the lateral side region of the sash 2.

Different modifications may be applied to the above embodiments.

The foil 6 can be directly disposed on one or both of the aluminium members 4, 5 without providing the plastic profile 12a or the plastic strip 12. The thickness of the foil 6 can be less than 1 μm. A surface of one or both of the aluminium members 4, 5, which faces the cavity 9, can be partly or completely coated with a material having a low emissivity ε instead of providing the foil 6 with the low emissivity surface 6a or instead of providing the surface 5a of untreated aluminium.

The shapes of the aluminium members 4, 5 of the above embodiments do not have to be symmetric to each other. Instead of the aluminium members 4, 5 of the above embodiments, profiles made of different materials, in particular, different metals, can be used.

The connection ends 7a, 8a may have different shapes than the ones shown above and may be compatible with other grooves than the Technoform aluminium standard groove.

The untreated metal surface may be formed by a plastic carrier such as the plastic strip 12 or the plastic profile 12a comprising a foil or a piece of untreated metal and may be placed in position after anodising or powder coating.

Alternatively, the plastic carrier comprising the foil or the piece of untreated metal may be connected to the aluminium member 4, 5 and/or the first insulating strip 7 and/or the third aluminium member 23 before anodising or powder coating. In this case, the low emissivity surface may be protected by a protecting foil during the anodising or powder coating process. Depending on the process, the protecting foil may not be necessary.

The plastic profile 12a or the plastic strip 12 may be disposed on either one or may be disposed on both of the first side 10 and the second side 11, and then be connected to the respective one of the first aluminium member 4 and the second aluminium member 5.

The plastic profile 12a in FIG. 1 is connected to one of the aluminium members 4, 5 via the clip connection 27. The plastic profile 12a shown FIG. 4 is connected to the first insulating strip 7 via the clip connection 28. A plastic profile may be used which is connected to one of the first and second aluminium members 4, 5 as well as to the first insulating strip 7. The plastic profile may be connected to the third aluminium member 23 via a clip connection alternatively or additionally to the above connections.

Due to the clip connection 28, the plastic profile 12a can be manufactured, transported, and stored separate from the first insulating strip 7, and can be mounted on the first insulating strip 7 before or during or after assembly of the sash 2. This facilitates manufacturing, transport and storage of the plastic profile 12a and the first insulating strip 7 and avoids breaking apart of the plastic profile 12a from the first insulating strip 7 during transport or storage.

Instead of or in addition to the untreated aluminium surface 5a of the second aluminium member 5, a surface of the first aluminium member 4 may be an untreated aluminium surface with an emissivity as described above.

The surface 5a or the part of the surface 5a does not necessarily have to be covered by a protecting foil during manufacturing steps after extrusion as long as a sufficiently low emissivity as described above can be ensured.

The above teaching may be applied to a sliding door instead of a sliding window. The sashes of the sliding system may be moved in a horizontal direction or may be moved in a vertical direction.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A sash for a sliding window or a sliding door, the sash comprising:
at least two metallic members connected by one or more insulating strips, wherein:
the two metallic members and one of the insulating strips at least partially confine a cavity having a first side in a direction (y) perpendicular to a plane (x-z) in which the sliding window or the sliding door extends and a second side opposite to the first side,
a low emissivity surface is disposed along the first side or the second side and has an emissivity ε of less than or equal to 0.3,
the low emissivity surface is formed by:
a non-treated surface of one of the two metallic members on the corresponding first or second side or
a low emissivity foil.

2. (canceled)

3. The sash according to claim 1, further comprising:
a plastic member disposed in the cavity,
wherein the low emissivity surface is formed by the low emissivity foil and is disposed on the plastic member.

4. The sash according to claim 3, wherein the plastic member extends from the one of the insulating strips, that partially confines the cavity.

5. The sash according to claim 4, wherein the plastic member is connected to the one of the insulating strips via a clip connection.

6. The sash according to claim 3, wherein the plastic member is connected to one of the metallic members via a clip connection.

7. The sash according to claim 3, wherein a second distance (d2) of the plastic member from one of the two metallic members on a side the low emissivity surface is facing is larger than a first distance (d1) of the plastic member from the other one of the two metallic members on the other side.

8. The sash according to claim 3, wherein the low emissivity foil at least partially comprises aluminium.

9. The sash according to claim 1, wherein the emissivity ε of the low emissivity surface is less than or equal to 0.1.

10. The sash according to claim 1, wherein the low emissivity surface extends at least substantially parallel to the first side or the second side.

11. The sash according to claim 1, wherein no foam is disposed in the cavity.

12. The sash according to claim 1, further comprising hardware for locking the sliding window or the sliding door in a closed state, in an open state or in a partly open state, the hardware being disposed in the cavity.

13. The sash according to claim 1, wherein the metallic members are made of aluminium.

14. The sash according to claim 1, wherein the at least two metallic members are connected by two or more of the insulating strips.

15. A method for imparting low emissivity to an untreated metal surface in a sash for a sliding window or a sliding door, the sash comprising at least two metallic members connected by one or more insulating strips, the two metallic members and one of the insulating strips at least partially confining a cavity having a first side in a direction perpendicular to a plane(x-z) in which the sliding window or the sliding door extends and a second side opposite to the first side, and the low emissivity surface being disposed along the first side or the second side, the method comprising:
covering at least a part of a surface of one of the two metallic members that faces the cavity in an assembled state of the sash, with a protecting foil,
performing a surface treatment on at least one of the metallic members, and
removing the protecting foil from the surface after the surface treatment.

16. The sash according to claim 3, wherein:
the plastic member is spaced apart from a first one of the two metallic members by a first distance (d1),
the plastic member is spaced apart from a second one of the two metallic members by a second distance (d2),
the low emissivity foil is disposed on a side of the plastic member that faces the second one of the two metallic members, and
the second distance (d2) is greater than the first distance (d1).

17. The sash according to claim 16, wherein:
the low emissivity foil at least partially comprises aluminium,
the emissivity ε of the low emissivity foil is less than or equal to 0.1, and
the low emissivity foil extends at least substantially parallel to the first side or the second side of the cavity.

18. The sash according to claim 17, wherein no foam is disposed in the cavity.

19. The sash according to claim 18, wherein:
the metallic members are made of aluminium, and
two or more of the insulating strips connect the metallic members.

20. The sash according to claim 19, wherein the insulating strips are composed of a glass fiber reinforced plastic material.

21. The sash according to claim 20, wherein the metallic members have a wall thickness of 0.3-2 cm and the insulating strips have a wall thickness of 0.5-3 mm.
